(19) United States
(12) Patent Application Publication
(10) Pub. No.: US 2007/0296882 A1
(43) Pub. Date: Dec. 27, 2007

(54) Thin film transistor array

(76) Inventors: Jau-Ching Huang, Luodong Township (TW); Chien-Chih Jen, Taipei City (TW); Huei-Chung Yu, Taoyuan City (TW); Meng-Feng Hung, Jhonghe City (TW); Wen-Hsiung Liu, Neipu Township (TW); Hung-Jen Chu, Jhongli City (TW)

Correspondence Address: J.C. Patents, Inc., Suite 250, 4 Venture, Irvine, CA, 92618, US

(21) Appl. No.: 11/473,946

(22) Filed: Jun. 23, 2006

(51) Int. Cl. G02F 1/136

(52) U.S. Cl. 349/43

(57) ABSTRACT

A thin film transistor array comprising a substrate, thin film transistors, pixel electrodes, common lines, and auxiliary electrodes disposed on the substrate is provided. The substrate has a plurality of pixel regions, and each of the thin film transistors, pixel electrodes, and auxiliary electrodes are disposed in each pixel region. In each pixel region, the pixel electrode is covered over the common line and is electrically connected to the thin film transistor. The auxiliary electrode is located between the pixel electrode and the common line, and the area of the overlapping region between the auxiliary electrode and the common line is L×H, while the sum of the side lengths of the overlapping region is more than 2L×2H, wherein L and H are both positive real numbers. The individual feed-through voltages in each pixel regions in the thin film transistor array are the same.

### BACKGROUND OF THE INVENTION

1. Field of Invention

The present invention relates to a thin film transistor array. More particularly, the present invention relates to a thin film transistor array capable of enhancing the uniformity of display luminance of a display device.

2. Description of Related Art

A thin film transistor liquid crystal display (TFT-LCD) device mainly comprises a thin film transistor array, a color filter, and a liquid crystal layer. In FIG. 1, a schematic partial view of a conventional thin film transistor array is depicted. Referring to FIG. 1, a thin film transistor array 100 mainly includes a plurality of pixel structures 110 arranged in an array. Each pixel structure 110 includes a scan line 112, a data line 114, a thin film transistor 116, and a pixel electrode 118 electrically connected to the thin film transistor 116.

Referring again to FIG. 1, the thin film transistor 116 acts as a switching element for the pixel structure 110, while the scan lines 112 and the data lines 114 are used for providing an appropriate operating voltage for the selected pixel structures 110 to drive the individual pixel structures 110 respectively for displaying images. In addition, the pixel structure 110 further includes an auxiliary electrode 120 disposed over a common line 130 of the thin film transistor array 100.

FIG. 2 depicts a schematic equivalent circuit diagram of a single pixel in a conventional TFT-LCD. Referring to FIG. 2, a single pixel of a conventional TFT-LCD generally includes a thin film transistor 116, a liquid crystal capacitance C_{LC}, and a storage capacitance Cₛₜ.

Referring to both FIG. 1 and FIG. 2, the liquid capacitance C_{LC} is formed by coupling a pixel electrode 118 to a common electrode (not shown) on the color filter, while the storage capacitance Cₛₜ is formed by coupling the auxiliary electrode 120 to the common line 130. Additionally, a gate G, a source S, and a drain D of the thin transistor 116 are connected respectively to the scan line 112, the data line 114, and the pixel electrode 118. Furthermore, due to an overlapping region between the gate G and the drain D, a gate-drain parasitic capacitance C_{gd} is formed there between.

Referring again to FIGS. 1 and 2, the voltage applied to the liquid crystal capacitance C_{LC}, i.e. the voltage applied to the pixel 118 and the common electrode, is specifically correlated with the light transmittance of the liquid molecule. As a result, the display can display a predetermined image simply by controlling the voltage applied to the liquid crystal capacitance C_{LC} in accordance with the image to be displayed. When the thin film transistor 116 is turned off, the voltage on the liquid crystal capacitance C_{LC} remains at a fixed value, i.e. in a holding state. However, due to the presence of the gate-drain parasitic capacitance C_{gd}, the voltage maintained on the liquid crystal capacitance C_{LC} will vary with the changes in the signal on the data line 114, i.e. the so-called coupling effect, so that the voltage maintained on the liquid crystal capacitance C_{LC} will deviate from the originally set value. This variation in the voltage is referred as a feed-through voltage ΔVₚ, represented by

$$Δ {V}_{p} = \frac{{C}_{gd}}{{C}_{gd} + {C}_{st} + {C}_{LC}} Δ {V}_{g} , \qquad ( 1 )$$

where ΔV_{g} is the amplitude of the impulse voltage applied to the scan line 112. If the feed-through voltages of individual pixels are different, the problem of mura will be occurred. As shown in equation (1), the magnitudes of the gate-drain parasitic capacitance C_{gd}, the liquid crystal capacitance C_{LC}, and the storage capacitance Cₛₜ are all related to the display quality of the LCD.

Currently, the exposure process of thin film transistor arrays is to divide the panel into multiple regions and expose individual regions one by one with a step exposure machine or a scan exposure machine. However, in the above two exposure processes, the exposure intensity in each individual region differs from each other because of errors in the process. Once the exposure intensity received by each individual region differs from each other, in the following etching process to form the drain and the auxiliary electrode, the drain and the auxiliary electrode will have different undercut amounts among individual regions, causing different sizes of the drain and the auxiliary electrode among individual pixels. As a result, the feed-through voltages ΔVₚ of individual pixels will differ from each other, resulting in the mura problem in LCDs.

### SUMMARY OF THE INVENTION

Accordingly, the present invention is directed to provide a thin film transistor array, which is to solve the mura problem in LCDs due to errors in the process.

In order to achieve the above and other objects, the present invention provides a thin film transistor array, which comprises a substrate, and a plurality of thin film transistors, a plurality of pixel electrodes, a plurality of common lines, and a plurality of auxiliary electrodes disposed on the substrate. The substrate has a plurality of pixel regions, with a thin film transistor, a pixel electrode, and an auxiliary electrode arranged in each pixel region respectively. In each pixel region, the pixel electrode is covered on the common line and is electrically connected to the thin film transistor. Meanwhile, the auxiliary electrode is disposed between the pixel electrode and the common line, whereby the area of the overlapping region between the auxiliary electrode and the common line is L×H, while the sum of the side lengths of the overlapping region is more than L×H, wherein L and H are both positive real numbers.

In an embodiment of the invention, the aforementioned auxiliary electrodes are electrically connected to corresponding pixel electrodes respectively. For example, an insulation layer having a plurality of contact holes is provided between the pixel electrodes and the auxiliary electrodes. The pixel electrodes are filled into the contact holes to be electrically connected with the auxiliary electrodes.

In an embodiment of the invention, the aforementioned auxiliary electrodes have, for example, a plurality of block portions and at least one neck portion positioned between the block portions. The neck portion has, for example, a comb shape or a continuously curved shape. In addition, in another embodiment, each auxiliary electrode comprises, for example, a plurality of bock electrodes that are not interconnected.

In an embodiment of the invention, the aforementioned common line in each pixel region has an H-shape, as well as the auxiliary electrode.

In an embodiment of the invention, a drain region of the thin film transistor has an H-shape.

In an embodiment of the invention, a gate electrode of the thin film transistor has an H-shape.

The invention may be designed with specific patterns to increase the sum of the side lengths of the overlapping region between the auxiliary electrode and the common line without changing the area of the auxiliary electrodes, so that the difference between the areas of the overlapping regions in different pixel regions constantly maintains a certain proportional relation with the difference between the area of the overlapping region between the gate and the drain, thus having the feed-through voltages in individual pixel regions equal to each other.

In order to the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic top view of a conventional thin film transistor array.

FIG. 2 is a schematic equivalent circuit diagram of a single pixel of a conventional thin film transistor LCD.

FIG. 3A is a partial top view of a thin film transistor array in an embodiment of the invention.

FIG. 3B is a schematic sectional view of the thin film transistor array of FIG. 3A taken along line I-I′.

FIG. 4 through FIG. 9 are respectively partial top views of thin film transistor arrays in other embodiments of the invention.

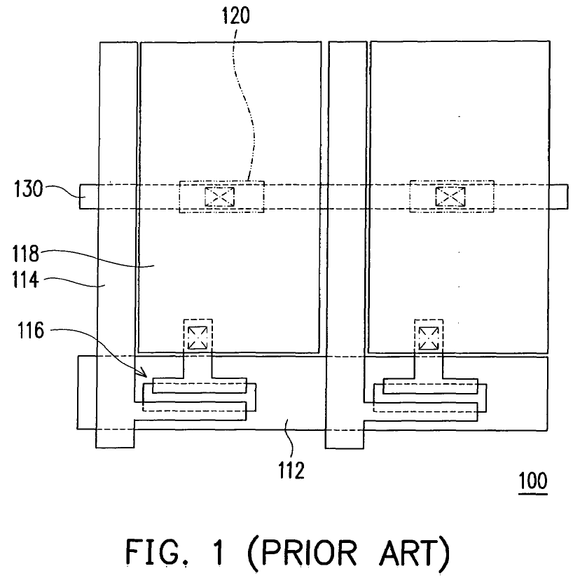

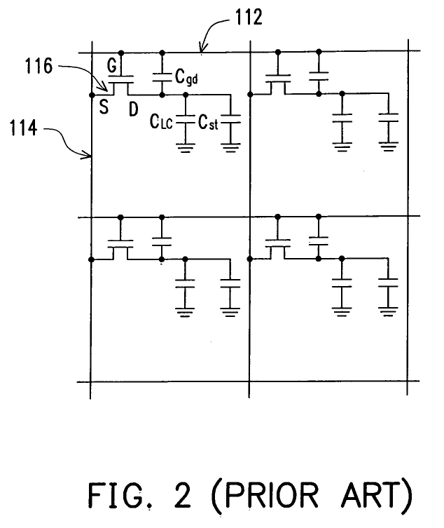

### DESCRIPTION OF EMBODIMENTS

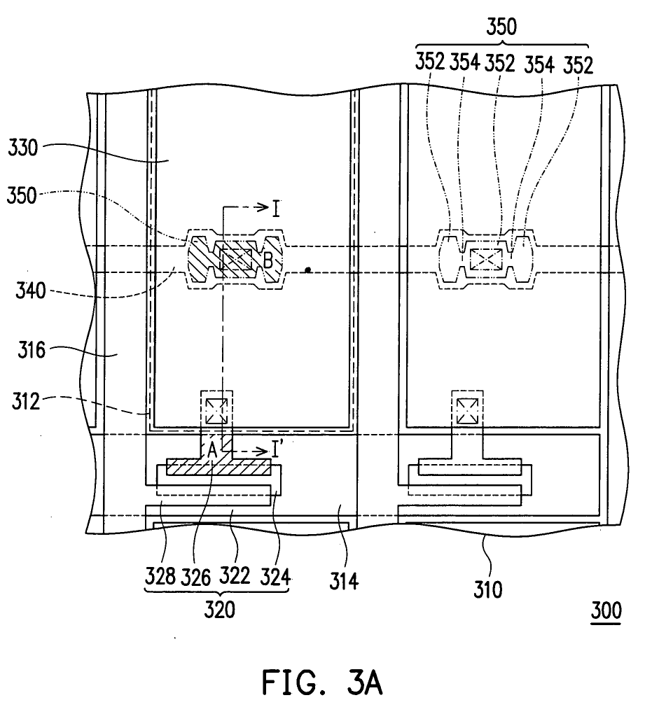

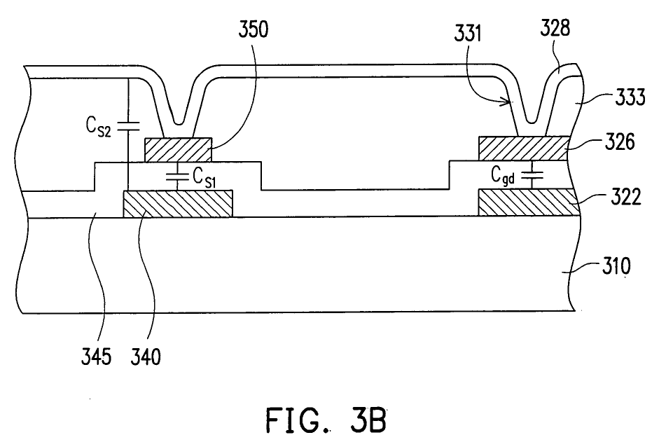

FIG. 3A is a partial top view of a thin film transistor array in an embodiment of the invention, and FIG. 3B is a sectional view of the thin film transistor array of FIG. 3A taken along line I-I′. Referring to FIG. 3A, a thin film transistor array 300 comprises a substrate 310, a plurality of thin film transistors 320, a plurality of pixel electrodes 330, a plurality of common lines 340, and a plurality of auxiliary electrodes 350. The substrate 310 has a plurality of pixel regions 312, while the thin film transistors 320, the pixel electrodes 330 and the auxiliary electrodes 350 are respectively disposed in individual pixel regions 312. Here, those skilled in the art should be aware that the pixel regions 312 are divided by scan lines 314 and data lines 316 formed on the substrate 310.

The transistor 320 mainly includes a gate 322, a channel layer 324, a source 326, and a drain 328, wherein the gate 322 is electrically connected to the scan line 314, and a part of the scan line 314 is taken as the gate 322 of the thin film transistor 320 in the present embodiment. The channel layer 324 is disposed on the gate 322, the source 326 and the drain 328 partially cover the channel layer 324, while an overlapping region A is provided between the drain 328 and the gate 322, so that a gate-drain parasitic capacitance C_{gd} is formed there-between.

Referring to both FIG. 3A and FIG. 3B, the pixel electrode 330 is electrically connected to the source 326 of the thin film transistor 320 and covers the common line 340. The auxiliary electrode 350 is located between the pixel electrode 330 and the common line 340 to form an overlapping region B with the common line 340. The auxiliary electrode 350 belongs to the same film as the source 326 and the drain 328 of the thin film transistor 320, and a dielectric layer 333 is disposed between the pixel electrode 330 and the source 326, the drain 328, and the auxiliary electrode 350. The dielectric layer 333 has, for example, a plurality of contact holes 331, through which the pixel electrodes 330 are electrically connected to the auxiliary electrodes 350 and the sources 326. Similarly, a dielectric layer 345 is further provided between the common line 340 and the auxiliary electrode 350, and a storage capacitor Cₛₜ is formed by coupling the auxiliary electrode 350, the dielectric layer 345, and the common line 340. Of course, a storage capacitance C_{S2} is also provided between the pixel electrode 330 and the common line 340. It can be seen that the equivalent storage capacitance Cₛₜ of the thin film transistor array 300 in each pixel region 312 is (Cₛ₁+Cₛ₂).

Referring again to FIG. 3A, it should be noted that the area of the overlapping region B is L×H, and the sum of the side lengths the overlapping region is more than 2L×2H, wherein L and H are both positive real numbers. That is to say, the area of the overlapping region B amounts to that of a rectangle having a length L and a width H (not shown), while the sum of the side lengths of the overlapping region B is larger than that of the rectangle.

As apparent from the above description, the invention increases the sum of the side lengths of the overlapping region B to the greatest amount, under the condition that the area of the overlapping region B is maintained at an appropriate value. In this way, even if the gate 322, the drain 328, and the auxiliary electrode 350 have different undercut amounts in individual pixel regions 312 due to errors during the process, the differential between the areas of the overlapping region B in different pixel regions 312 maintains an appropriate proportion with the differential between the areas of the overlapping region A in different pixel regions 312. That is to say, although different pixel regions 312 have different storage capacitances Cₛₜ and gate-drain parasitic capacitances C_{gd}, individual pixel regions 312 could have the same feed-through voltage according to the equation (1), because of the same proportional relation between the storage capacitance Cₛₜ and the gate-drain parasitic capacitance C_{gd} in each pixel region 312, thereby avoiding the mura problem in a display employing the thin film transistor array 300.

Illustratively described hereinafter is a design pattern of the auxiliary electrode of the invention, which is not intended to limit the invention.

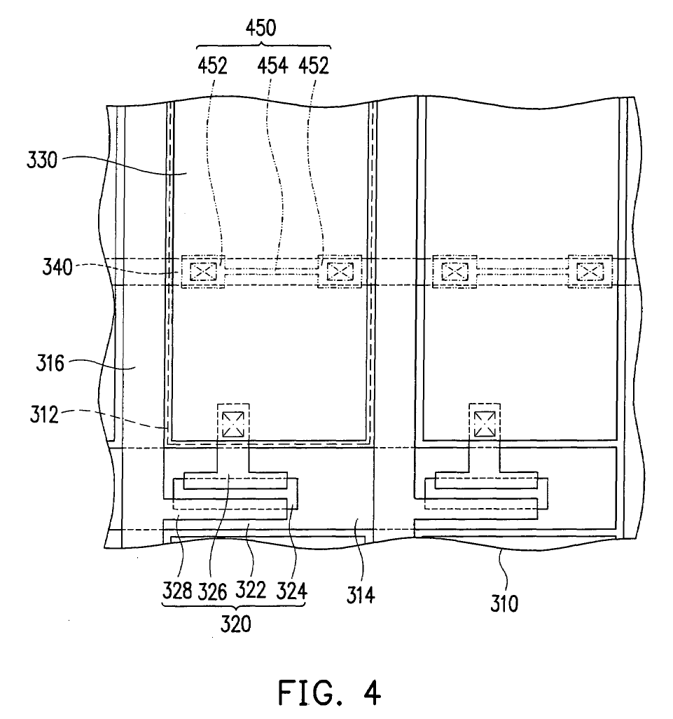

Referring still to FIG. 3A, the auxiliary electrode 350 of the invention has an area equal to that of the overlapping region B, and has, for example, three block portions 352 and two neck portions 354, wherein the neck portions 354 are connected between two adjacent block portions 352. Of course, in other embodiments, an auxiliary electrode 450 may only partially overlap the common line 340 and have two block portions 452 and one neck portion 454 as shown in FIG. 4. It can be seen that the invention does not limit the amounts of the block and neck portions of the auxiliary electrode.

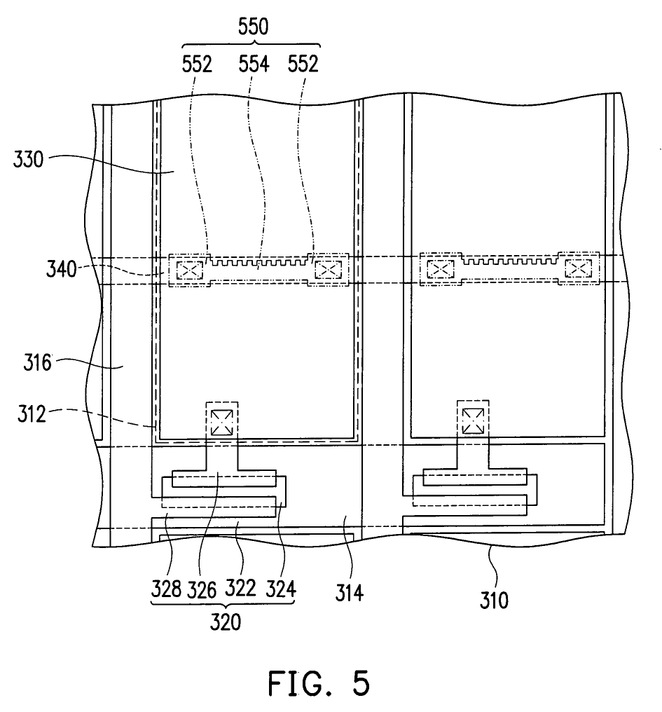

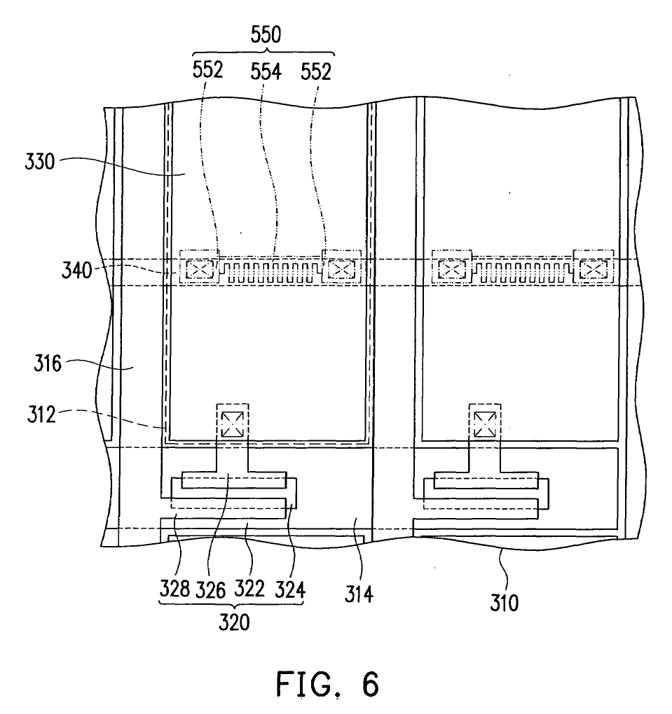

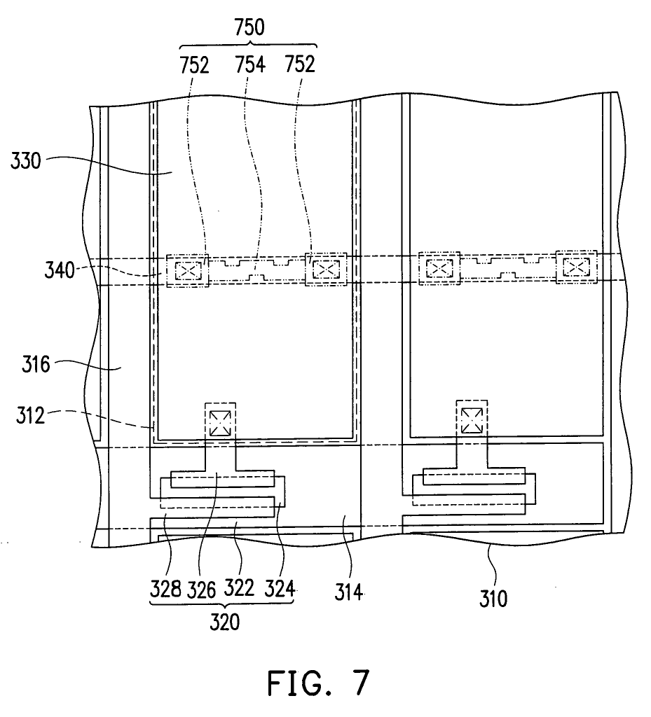

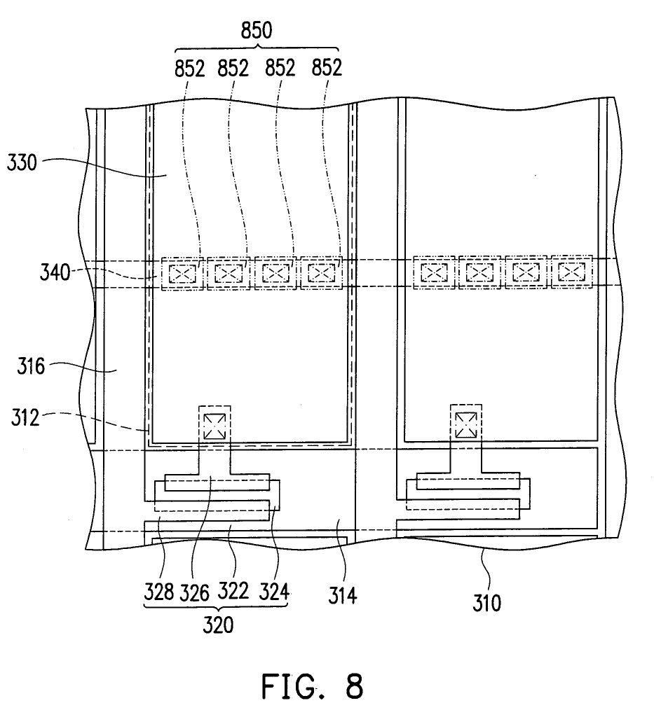

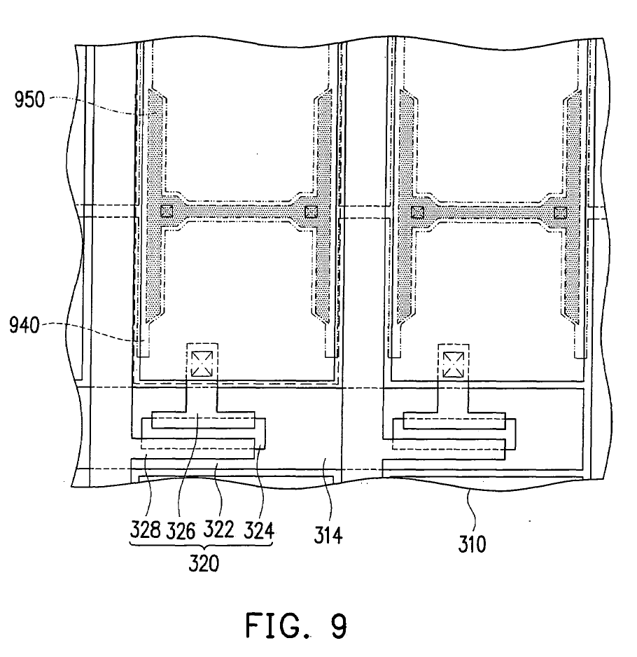

In addition, a neck portion 554 of an auxiliary electrode 550 can also be designed to have a comb shape as shown in FIGS. 5 and 6. Alternatively, a neck portion 754 of an auxiliary electrode 750 can have a continuously curved shape. Furthermore, an auxiliary electrode 850 may further comprise a plurality of block electrodes 852 separated from each other as shown in FIG. 8. As shown in FIG. 9, an auxiliary electrode 950 may also have an H-shape, and a common line 940 also has an H-shape in this embodiment.

As apparent from the above description, according to the invention, the auxiliary electrode in each pixel region may has an area the same as that of a conventional rectangle auxiliary electrode, while the sum of its side lengths is larger than that of the conventional auxiliary electrode, so that the differential between the areas of the storage capacitances in different pixel regions has an appropriate proportional relation with the differential between the areas of the gate-drain parasitic capacitances in different pixel regions, thereby having the feed-through voltages in individual pixel regions equal to each other.

Of course, the invention does not limit the pattern of the drain and the gate of the thin film transistor to what is shown in the drawings of the aforementioned embodiments, but those skilled in the art may determine by themselves the pattern of the drain in accordance with the practical process. In other words, the pattern of the drain can also be H shape and the gate can also be H shape.

Hereinafter, the thin film transistor array 300 will be taken as an example to describe how a thin film transistor array of the invention achieves the aforementioned advantages.

Referring to FIG. 3A, it is assumed that in two different pixel regions 312, the difference between the undercut amounts of the drain 326 and the auxiliary electrode 350 is d_{sd}, while the difference between the undercut amounts of the gate 322 and the common line 340 is d_{ge}, and the sum of the side lengths of the drain 326 above the gate 324 is L_{sd}, the side length of the overlapping border between the drain 326 and the gate 322 is L_{ge}, the sum of the side lengths of the overlapping region B is Lₛ₁, and the sum of the side lengths of the overlapping region between the common line 340 and the pixel electrode 330 is Lₛ₂. Accordingly, the difference between the areas of the gate-drain parasitic capacitances C_{gd} of the two pixel regions 312 is L_{sd}×d_{sd}+L_{ge}×d_{ge}, while the difference between the areas of the storage capacitances Cₛ₁ is Lₛ₁×d_{sd}, and the difference between the areas of the storage capacitances Cₛ₂ is Lₛ₂×d_{ge}.

As shown in the equation (1), the feed-through voltage ΔVₚ is directly proportional to the gate-drain parasitic capacitance C_{gd}, while inversely proportional to (C_{gd}+Cₛₜ+C_{LC}). Thus, the difference between the storage capacitances Cₛₜ of the two Is pixel regions 312 will maintain an appropriate proportional relation with the difference between the gate-drain parasitic capacitances C_{gd}. Only in this way can the feed-through voltages ΔVₚ in individual pixel regions 312 be the same. Also, as apparent from the above description, the difference between the gate-drain parasitic capacitances of the two pixel regions 312 is directly proportional to L_{sd}×d_{sd}+L_{ge}×d_{ge}, while the difference between the storage capacitances Cₛₜ is directly proportional to Lₛ₁×d_{sd}+Lₛ₂×d_{ge}. By designing the storage electrode with a specific pattern, the invention can increase the sum of the side lengths Lₛ₁ of the overlapping region B, so that the difference between the storage capacitances Cₛₜ has an appropriate proportional relation with the difference between the gate-drain capacitances C_{gd}. In this way, the thin film transistor array 300 will have same feed-through voltage in different pixel regions 312.

Similarly, the invention can also specifically design the pattern of the common line 340, so as to increase the sum of its side length Lₛ₂. In other words, the invention have the difference between the storage capacitances Cₛₜ maintain an appropriate proportional relation with the difference between the gate-drain parasitic capacitances C_{gd} by increasing the sum of the side length Lₛ₁ or Lₛ₂, or even by increasing the two at the same time.

To sum up, the invention increases the sum of the side lengths of the overlapping region between the auxiliary electrode and the common line through specific pattern designs without varying the area of the auxiliary electrode, so that even if the areas of the overlapping region differ in different pixel regions due to errors in the process, the difference thereof constantly maintains a certain proportional relation with that of the areas of the overlapping regions between the gate and the drain. In this way, n LCD using the thin film transistor array of the invention can exhibit a preferable display quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A thin film transistor array, comprising:
a substrate having a plurality of pixel regions;
a plurality of thin film transistors disposed in each of the pixel regions respectively;
a plurality of pixel electrodes disposed in each of the pixel regions respectively, and electrically connected to the thin film transistors;
a plurality of common lines disposed on the substrate, wherein the pixel electrodes are covered over the common line in each of the pixel regions respectively; and
a plurality of auxiliary electrodes disposed in each of the pixel regions respectively and located between the pixel electrodes and the common lines, an overlapping region is formed between each of the auxiliary electrodes and the corresponding common line, wherein an area of the overlapping region is L×H, while a sum of the side lengths of the overlapping region is more than 2L×2H, and L and H are both positive real numbers.

2. The thin film transistor array as claimed in claim 1, wherein the auxiliary electrodes are electrically connected to corresponding pixel electrodes respectively.

3. The thin film transistor array as claimed in claim 2, further comprising an insulation layer disposed between the pixel electrodes and the auxiliary electrodes, the sources, and the drains.

4. The thin film transistor array as claimed in claim 3, wherein the insulation layer has a plurality of contact holes, and the pixel electrodes are respectively filled into the contact holes, thereby being electrically connected to the auxiliary electrodes.

5. The thin film transistor array as claimed in claim 1, wherein each of the auxiliary electrodes has a plurality of block portions and at least one neck portion located between the block portions.

6. The thin film transistor array as claimed in claim 5, wherein each of the neck portions has a comb shape.

7. The thin film transistor array as claimed in claim 5, wherein each of the neck portions has a continuously curved shape.

8. The thin film transistor array as claimed in claim 1, wherein each of the auxiliary electrodes comprises a plurality of block electrodes that are not interconnected.

9. The thin film transistor array as claimed in claim 1, wherein the common line in each of the pixel regions has an H-shape.

10. The thin film transistor array as claimed in claim 9, wherein each of the auxiliary electrodes has an H-shape.

11. The thin film transistor array as claimed in claim 1, wherein a drain of the thin film transistor has an H-shape.

12. The thin film transistor array as claimed in claim 1, wherein a gate of the thin film transistor has an H-shape.
